(19) United States
(12) Patent Application Publication
(10) Pub. No.: US 2009/0285246 A1
(43) Pub. Date: Nov. 19, 2009

(54) MULTI-RESONANT OPTICAL FIBER LASER SYSTEM

(75) Inventors: Hong Seok Seo, Daejeon-city (KR); Joon Tae Ahn, Daejeon-city (KR); Bong Je Park, Daejeon-city (JP); Taehyoung Zyung, Daejeon-city (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon-city (KR)

(21) Appl. No.: 12/233,053

(22) Filed: Sep. 18, 2008

(30) Foreign Application Priority Data
May 15, 2008 (KR) 10-2008-0045107

(51) Int. Cl. H01S 3/30

(52) U.S. Cl. 372/6

(57) ABSTRACT

Provided is a multi-resonant optical fiber laser system including a multi-resonator having an optical fiber containing at least one rare-earth element and an optical fiber inducing the stimulated Raman effect. The multi-resonant optical fiber laser system includes a pump light source irradiating pump light, a first resonator, which includes a first gain medium optical fiber containing at least one rare-earth element and first and second reflectors disposed to face each other across the first gain medium optical fiber and irradiates first laser radiation having a first wavelength by converting the pump light using the first gain medium optical fiber, a second resonator, which includes a second gain medium optical fiber inducing the stimulated Raman effect and third and fourth reflectors disposed to face each other across the second gain medium optical fiber and irradiates second laser radiation having a second wavelength by converting the first laser radiation using the second gain medium optical fiber. The multi-resonant optical fiber laser system furthermore may include a third resonator, which includes a second gain medium optical fiber inducing the stimulated Raman effect and fifth and sixth reflectors disposed to face each other across the second gain medium optical fiber and irradiates third laser radiation having a third wavelength by converting the second laser radiation using the second gain medium optical fiber.

### CROSS-REFERENCE TO RELATED PATENT APPLICATION

This application claims the benefit of Korean Patent Application No. 10-2008-0045107, filed on May 15, 2008, in the Korean Intellectual Property Office, the disclosure of which is incorporated herein in its entirety by reference.

### BACKGROUND OF THE INVENTION

1. Field of the Invention

The present invention relates to optical fiber laser system, and more particularly, to multi-resonant optical fiber laser system including multi-resonator formed of an optical fiber containing at least one rare-earth element and a optical fiber inducing a stimulated Raman effect.

2. Description of the Related Art

Fats in the human body include sebaceous glands under the surface of skin, subcutaneous fat within interior skin layers, and visceral fat accumulated in internal organs. Such fats are accumulated for preserving energy in the body, helping various types of metabolic processes, or preventing the drying-out of skin. However, in modern society, people take on excessive amounts of calories but perform insufficient physical activity requiring physical energy, and thus an excessive amount of fats are accumulated in the body. As a result, obesity is now a large social issue. Obesity not only causes aesthetic and psychological problems (such as depression), but also causes modern geriatric diseases including high blood pressure, high cholesterol, and diabetes. Although physical exercises and/or diets can be performed to lose weight and overcome obesity, it is not easy to remove accumulated fat in a body. Therefore, recently more and more people are being aided by surgical operations such as lipectomy for aesthetic reasons or health-related reasons. An example of lipectomy is liposuction which involves the removing of fats by sucking out fat cells using a mechanical suction device. However, a reported number of problems in liposuction have been reported, the problems include removing of normal cells (which are not fat cells), the need for a long recovery period for the patient, pains from the aftereffects of the surgery, and even the death of patients during the surgery.

Recently, methods of surgery involving the combusting of fats by using optical energies such as those provided by a laser have been disclosed and carried out. Lasers generally used in lipectomy are CO₂ lasers or Nd-YAG lasers. To effectively remove fats from the body, it is preferable that fats or fat cells absorb more thermal energy irradiated from the laser than other elements or tissues in the body. Specifically, since water occupies 70% of the body, it is preferable to select a wavelength of laser which is not likely to be absorbed by water, so that destruction of normal cells can be prevented and the depth to which the laser radiation is transmitted into skin can be guaranteed. Also, to effectively remove fats in a body, it is required to select a wavelength of laser which is highly absorbed by fats.

The optimal range of wavelengths of a laser for removing fats is disclosed in U.S. Pat. No. 6,605,080. However, the ranges of wavelengths of the aforementioned CO₂ lasers and Nd-YAG lasers are not included in the optimal range of wavelengths of laser for removing fats.

### SUMMARY OF THE INVENTION

The present invention provides a multi-resonant optical fiber laser system, which can irradiate laser radiation with wavelengths highly absorbable to fats in the human body while not being highly absorbable by water and other cells of the human body, and thus can be effectively used in lipectomy.

According to an aspect of the present invention, there is provided a multi-resonant optical fiber laser system including a pump light source irradiating pump light, a first resonator and a second resonator. The first resonator includes

a first gain medium optical fiber containing at least one rare-earth element, and first and second reflectors disposed to face each other across the first gain medium optical fiber. The first resonator irradiates first laser radiation having a first wavelength by converting the pump light using the first gain medium optical fiber. The second resonator includes a second gain medium optical fiber inducing a stimulated Raman effect, and third and fourth reflectors disposed to face each other across the second gain medium optical fiber. The second resonator irradiates second laser radiation having a second wavelength by converting the first laser radiation using the second gain medium optical fiber.

In some embodiments of the present invention, the rare-earth element may be Yb (ytterbium), Er (erbium), Tm (Thulium), or a mixture thereof.

In some embodiments of the present invention, the first wavelength may be between 1030 nm and 1170 nm, between 1525 nm and 1625 nm, or between 1750 nm and 2100 nm. The second wavelength may be between 1070 nm and 1250 nm, between 1620 nm and 1770 nm, or between 1180 nm and 2350 nm.

In some embodiments of the present invention, the rare-earth element may be Yb, the first wavelength may be between 1030 nm and 1170 nm, and the second wavelength may be between 1070 nm and 1250 nm. The rare-earth element may be either Er or a mixture of Er and Yb, the first wavelength may be between 1525 nm and 1625 nm, and the second wavelength may be between 1620 nm and 1770 nm. The rare-earth element may be Tm, the first wavelength may be between 1750 and 2100 nm, and the second wavelength may be between 1880 nm and 2350 nm.

In some embodiments of the present invention, the first resonator and the second resonator may be either disposed apart from each other or are overlapped. The second gain medium optical fiber of the second resonator may be disposed between the first and second reflectors. Possible sequences in which the first through fourth reflectors are disposed in a direction away from the pump light source may be: the first reflector, the second reflector, the third reflector, and the fourth reflector; the first reflector, the third reflector, the second reflector, and the fourth reflector; the first reflector, the third reflector, the fourth reflector, and the second reflector; the third reflector, the first reflector, the second reflector, and the fourth reflector; the third reflector, the first reflector, the fourth reflector, and the second reflector; and the third reflector, the fourth reflector, the first reflector, and the second reflector.

In some embodiments of the present invention, the first through fourth reflectors may be each independently a FBG (optical fiber Bragg grating), a dichroic mirror, a partial reflection mirror, a optical fiber loop mirror, or a mirror coated with dielectric substance.

In some embodiments of the present invention, the range of the center wavelength of the first reflector and the range of the center wavelength of the second reflector may correspond to each other, and the range of the center wavelength of the third reflector and the range of the center wavelength of the fourth reflector may correspond to each other.

In some embodiments of the present invention, the first reflector may have a reflectivity between 5% and 50% or a reflectivity between 90% and 100% with respect to the first laser radiation. The second reflector may have a reflectivity between 5% and 50% or a reflectivity between 90% and 100% with respect to the first laser radiation. The third reflector may have a reflectivity between 90% and 100% with respect to the second laser radiation. The fourth reflector may have a reflectivity between 5% and 50% with respect to the second laser radiation.

In some embodiments of the present invention, two of the first through fourth reflectors may be multi-reflectors composed of a single body.

In some embodiments of the present invention, the first gain medium optical fiber, the second gain medium optical fiber, or both may comprise silica as host glass. The first gain medium optical fiber, the second gain medium optical fiber, or both may further comprise Al₂O₃, GeO₂, or both. The second gain medium optical fiber may comprise Ge (germanium).

In some embodiments of the present invention, the first gain medium optical fiber, the second gain medium optical fiber, or both are optical fibers may have either a single cladding structure or a double cladding structure.

In some embodiments of the present invention, the multi-resonant optical fiber laser system may further comprise a light intensity modulator, a light phase modulator, light saturation absorber, or an acousto-optic modulator.

According to an aspect of the present invention, there is provided a multi-resonant optical fiber laser system comprising a pump light source irradiating pump light, a first resonator, a second resonator, and a third resonator. The first resonator comprises a first gain medium optical fiber containing at least one rare-earth element, and first and second reflectors disposed to face each other across the first gain medium optical fiber. The first resonator irradiates first laser radiation having a first wavelength by converting the pump light using the first gain medium optical fiber. The second resonator comprises, a second gain medium optical fiber inducing a stimulated Raman effect, and third and fourth reflectors disposed to face each other across the second gain medium optical fiber. The second resonator irradiates second laser radiation having a second wavelength by converting the first laser radiation using the second gain medium optical fiber. The third resonator comprises fifth and sixth reflectors disposed to face each other across the second gain medium optical fiber. The third resonator irradiates third laser radiation having a third wavelength by converting the second laser radiation using the second gain medium optical fiber.

In some embodiments of the present invention, the first wavelength may be between 1030 nm and 1170 nm, between 1525 nm and 1625 nm, or between 1750 nm and 2100 nm. The second wavelength may be between 1070 nm and 1250 nm, between 1620 nm and 1770 nm, or between 1880 nm and 2350 nm. The third wavelength may be between 1110 nm and 1340 nm, between 1730 nm and 1950 nm, or between 2030 nm and 2670 nm.

In some embodiments of the present invention, the rare-earth element may be Yb, the first wavelength may be between 1030 nm and 1170 nm, the second wavelength may be between 1070 nm and 1250 nm, and the third wavelength is between 1110 nm and 1340 nm. The rare-earth element may be either Er or Er—Yb, the first wavelength may be between 1525 nm and 1625 nm, the second wavelength may be between 1620 nm and 1770 nm, and the third wavelength may be between 1730 nm and 1950 nm. The rare-earth element may be Tm, the first wavelength may be between 1750 nm and 2100 nm, the second wavelength may be between 1880 nm and 2350 nm, and the third wavelength may be between 2030 nm and 2670 nm.

In some embodiments of the present invention, positions of the first through third resonators may be either disposed apart from each other or are overlapped. Possible sequences in which the first through sixth reflectors are disposed in a direction away from the pump light source may be: first reflector, second reflector, third reflector, fifth reflector, fourth reflector, sixth reflector; first reflector, third reflector, fifth reflector, second reflector, fourth reflector, sixth reflector; and fifth reflector, third reflector, first reflector, second reflector, fourth reflector, sixth reflector.

In some embodiments of the present invention, the first through sixth reflectors may be each independently a FBG (optical fiber Bragg grating), a dichroic mirror, a partial reflection mirror, a optical fiber loop mirror, or a mirror coated with dielectric substance. The range of the center wavelength of the first reflector and the range of the center wavelength of the second reflector may correspond to each other, the range of the center wavelength of the third reflector and the range of the center wavelength of the fourth reflector may correspond to each other, and the range of the center wavelength of the fifth reflector and the range of the center wavelength of the sixth reflector may correspond to each other.

In some embodiments of the present invention, the fifth reflector may have a reflectivity between 90% and 100% with respect to the third laser radiation. The sixth reflector may have a reflectivity between 5% and 50% with respect to the third laser radiation.

In some embodiments of the present invention, two or three of the first through sixth reflectors may be multi-reflectors composed of a single body.

In some embodiments of the present invention, the second gain medium optical fiber may comprise Ge.

In some embodiments of the present invention, the first gain medium optical fiber, the second gain medium optical fiber, or both may be optical fibers having either a single cladding structure or a double cladding structure.

According to an aspect of the present invention, there is provided a multi-resonant optical fiber laser system comprising: a first resonator including a first gain medium containing at least one rare-earth element; and a second resonator including a second gain medium inducing a stimulated Raman effect. The multi-resonant optical fiber laser system irradiates laser radiation by using the first gain medium and the second gain medium in sequence.

In some embodiments of the present invention, the first resonator and the second resonator may be either disposed apart from each other or are overlapped.

In some embodiments of the present invention, the multi-resonant optical fiber laser system may further comprise a third resonator including the second gain medium optical fiber, wherein the multi-resonant optical fiber laser system irradiates laser radiation by using the first gain medium optical fiber and repeatedly using the second gain medium optical fiber.

In some embodiments of the present invention, positions of the first through third resonators may be either disposed apart from each other or are overlapped.

### BRIEF DESCRIPTION OF THE DRAWINGS

The above and other features and advantages of the present invention will become more apparent by describing in detail exemplary embodiments thereof with reference to the attached drawings in which:

FIG. 1 is a graph of the ratio of light absorption by fat to light absorption by water versus wavelength of light;

FIGS. 2 through 6 illustrate multi-resonant optical fiber laser systems through including first and second resonators, according to embodiments of the present invention;

FIGS. 7 through 9 illustrate multi-resonant optical fiber laser systems through according to other embodiments of the present invention;

FIG. 10A illustrates a dichroic mirror, which is a reflector included in the multi-resonant optical fiber laser systems shown in FIGS. 2 through 9, and an output unit according to an embodiment of the present invention;

FIG. 10B is a graph illustrating reflectivity characteristics of the dichroic mirror of FIG. 10A with respect to wavelengths;

FIG. 11A illustrates a optical fiber loop mirror, employed as a reflector in the multi-resonant optical fiber laser systems shown in FIGS. 2 through 9, according to an embodiment of the present invention;

FIG. 11B is a graph illustrating reflectivity characteristics of the optical fiber loop mirror of FIG. 11A with respect to wavelengths; and

FIG. 12 illustrates an acousto-optic modulator, which is for Q-switching laser and is connected to a reflector included in the multi-resonant optical fiber laser systems shown in FIGS. 2 through 9.

### DETAILED DESCRIPTION OF THE INVENTION

Reference will now be made in detail to example embodiments, examples of which are illustrated in the accompanying drawing. However, example embodiments are not limited to the embodiments illustrated hereinafter, and the embodiments herein are rather introduced to provide easy and complete understanding of the scope and spirit of example embodiments. In the drawings, the thicknesses of layers and regions are exaggerated for clarity.

It will be understood that when an element, such as a layer, a region, or a substrate, is referred to as being “on,” “connected to” or “coupled to” another element, it may be directly on, connected or coupled to the other element or intervening elements may be present. In contrast, when an element is referred to as being “directly on,” “directly connected to” or “directly coupled to” another element or layer, there are no intervening elements or layers present. Like reference numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments.

Spatially relative terms, such as “above,” “upper,” “beneath,” “below,” “lower,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “above” may encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but may be to include deviations in shapes that result, for example, from manufacturing. For example, an implanted region illustrated as a rectangle may, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes may be not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention is related to a multi-resonant optical fiber laser system. Generally, a optical fiber laser system includes a semiconductor light source as a pump light source, gain medium formed by doping a rare-earth element into a optical fiber core, and a pair of reflecting components such as mirrors at each end of the optical fiber. In such an optical fiber laser, pump light and laser light propagate through an optical fiber. Therefore, pump light (i.e., light generated by a pump light source) can be efficiently converted, and a resonator can be simply constructed since it is not necessary to align optical components. Furthermore, since the alignment of the resonator is not readily distorted, the output light of the optical fiber laser is stable, and the mode characteristics of the output light of the optical fiber laser are good. In addition, since the output end of optical fiber can be freely moved, the optical fiber laser can be conveniently used. Examples of the optical fiber laser include an ytterbium (Yb) optical fiber laser emitting light having a wavelength of about 1000 nm, an erbium (Er) optical fiber laser emitting light having a wavelength of about 1500 nm, and a thulium (Tm) optical fiber laser emitting light having a wavelength of about 2000 nm. Such optical fiber lasers have high output power or are wavelength tunable. Thus, optical fiber lasers are widely commercialized and used in, for example, industrial, medical, military, and scientific fields. Silica-based optical fiber is mainly used for the optical fiber lasers owing to its low light loss and heat-resisting characteristics. Furthermore, the silica-based optical fiber is suitable for high output power optical fiber lasers since the technology for manufacturing optical devices of a silica-based optical fiber laser is well-developed and silica-based optical fiber cables can be connected by fusing.

Furthermore, the present invention can be applied to a high-power output optical fiber laser system. The high-power output optical fiber laser system employs the structure of an optical fiber and a light pumping method different from the aforementioned general optical fiber laser systems. An optical fiber used in high-power output optical fiber laser system has a double-cladding structure. In double clad fiber, the outer cladding is coated with a polymer having a relatively low index of refraction, whereas the inner cladding is formed of silica-glass. The core uses silica-glass as a host glass, contains rare-earth elements, and may further include Al₂O₃ and GeO₂. Pump light, irradiated from a pump light source such as a semiconductor array diode laser, enters into the inner cladding, propagates, and enters into the core. In here, energy of the pump light is absorbed into the core, and laser radiation of a different wavelength is irradiated from the core. Such a high-power output optical fiber laser system has advantageous capabilities of irradiating high-power, single mode, or high-quality light. Furthermore, pump light enters into a cladding sectional area which is relatively larger than that of the core, and thus a large amount of light can enter into optical fibers. However, a laser system using optical fibers containing rare-earth elements is limited in the wavelength of laser radiation the laser system can irradiate.

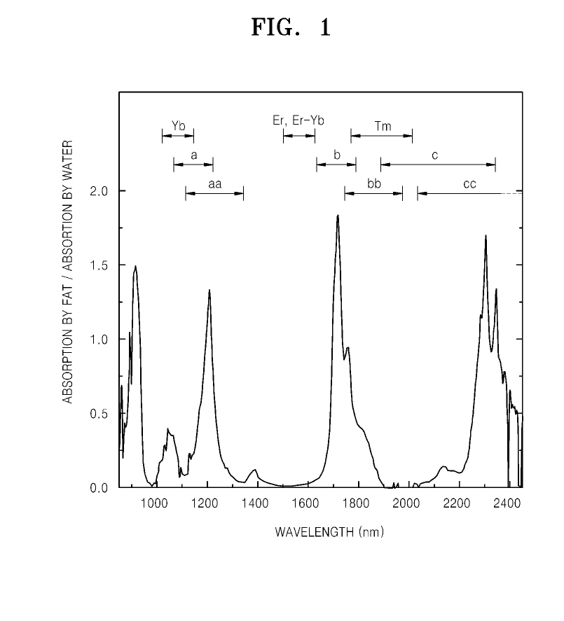

FIG. 1 is a graph of the ratio of light absorption by fat to light absorption by water versus wavelength of light.

Referring to FIG. 1, a greater peak is shown if the ratio of light absorption by fat to light absorption by water is greater, i.e. for wavelengths where fat absorbs far more light than water. Remarkable peaks exist in ranges of wavelengths between 1175 nm and 1230 nm, between 1690 nm and 1770 nm, and between 2270 nm and 2370 nm. However, the range of wavelength of light irradiated by optical fiber lasers containing a rare-earth material is different from those peaks. For example, light having a wavelength between 1030 nm and 1160 nm is irradiated when a rare-earth element contained in optical fiber laser is ytterbium (Yb). Light having a wavelength between 1525 nm and 1625 nm is irradiated when a rare-earth element contained in optical fiber laser is either erbium (Er) or a mixture of Er and Yb (Er—Yb). Furthermore, light having a wavelength between 1750 nm and 2100 nm is irradiated when a rare-earth element contained in optical fiber laser is thulium (Tm). Light having a wavelength outside the ranges of wavelengths cannot be irradiated by using optical fiber laser containing a rare-earth element hitherto.

The multi-resonant optical fiber laser system provided according to the present invention includes a resonator formed of one of the aforementioned optical fibers containing a rare-earth element together with another resonator formed of optical fibers inducing a stimulated Raman effect. Referring back to FIG. 1, ranges of wavelengths ‘a’, ‘aa’, ‘b’, ‘bb’, ‘c’, and ‘cc’ are ranges of wavelengths of lasers according to embodiments of the present invention. The ranges of wavelengths ‘a’ and ‘aa’ are ranges of wavelengths of lasers according to the embodiments of the present invention in the case where the rare-earth element contained in optical fiber laser is Yb. The ranges of wavelengths ‘b’ and ‘bb’ are ranges of wavelengths of lasers according to the embodiments of the present invention in the case where the rare-earth element contained in optical fiber laser is either Er or Er—Yb. The ranges of wavelengths ‘c’ and ‘cc’ are ranges of wavelengths of lasers according to the embodiments of the present invention in the case where the rare-earth element contained in optical fiber laser is Tm. The ranges of wavelengths partially belong to the ranges of wavelengths in which the amount of light absorbed by fat is high, and thus the present invention can embody a laser emitting light of which a higher amount is absorbed by fat as compared to the prior art.

Hereinafter, a configuration of multi-resonant optical fiber laser system according to the present invention will be described.

Multi-resonant optical fiber laser system according to the present invention includes a first resonator and a second resonator. The first resonator includes a first gain medium formed of optical fibers containing a rare-earth element, converts pump light, irradiated by a pump light source, to first laser radiation having a first wavelength by using the first gain medium, and irradiates the first laser radiation. The second resonator includes a second gain medium formed of optical fibers inducing the stimulated Raman effect, converts the first laser radiation to second laser radiation having a second wavelength by using the second gain medium, and irradiates the second laser radiation.

Furthermore, the multi-resonant optical fiber laser system may further include a third resonator. The third resonator includes the second gain medium, converts the second laser radiation to third laser radiation having a third wavelength by using the second gain medium, and irradiates the third laser radiation.

Examples of the rare-earth element may include Yb, Er, Tm, or a mixture thereof, for example a mixture of Er—Yb.

The stimulated Raman effect will be described hereinafter. First, the Raman effect refers to an effect in which, when light having a single wavelength, such as laser radiation, is irradiated onto a material and scattered, spectral lines having wavelengths either longer or shorter than that of the irradiated light are also observed. In other words, light having a wavelength different from that of light originally irradiated is observed. When a laser having a frequency F₀ is irradiated onto a material inducing the Raman effect, phase of the frequency F₀ is shifted by Fᵣ, wherein Fᵣ refers to the natural vibrating frequency of the material. Thus, Raman light having a frequency of F₀+Fᵣ or F₀−Fᵣ is irradiated. Vibration is excited in the material by a beat effect due to the Raman light and the irradiated laser, and thus the Raman light becomes more intense. The effect is referred as the stimulated Raman effect. The Raman light has excellent monochromatic and directional properties. Examples of materials inducing the stimulated Raman effect includes germanium (Ge).

The range of the first wavelength may depend on the range to which light is irradiated from a silica optical fiber containing the rare-earth element. In an optical fiber inducing the Raman effect, for example, an optical fiber doped with Ge, wavelength conversion due to the Raman effect is generally 440 cm⁻¹, and thus the range of the second wavelength may be a range 400 cm⁻¹ to 500 cm⁻¹ away above and below 440 cm⁻¹, where 440 cm⁻¹ is the center of the stimulated Raman effect. The reason is that the stimulated Raman effect is more remarkable within this range. In other words, a range of 400 cm⁻¹ to 500 cm⁻¹ away from the range of the first wavelength is a range of the second wavelength. Similarly, a range of the third wavelength may be a range 400 cm⁻¹ to 500 cm⁻¹ away from the range of the second wavelength.

Therefore, the first wavelength may be between 1030 nm and 1170 nm, between 1525 nm and 1625 nm, or between 1750 nm and 2100 nm. Furthermore, the second wavelength may be between 1070 nm and 1250 nm, between 1620 nm and 1770 nm, or between 1880 nm and 2350 nm. Furthermore, the third wavelength may be between 1110 nm and 1340 nm, between 1730 nm and 1950 nm, or between 2030 nm and 2670 nm.

More particularly, when the rare-earth element is Yb, the first wavelength may be between 1030 nm and 1170 nm, and the second wavelength may be between 1070 nm and 1250 nm. Otherwise, when the rare-earth element is either Er or Er—Yb, the first wavelength may be between 1525 nm and 1625 nm, and the second wavelength may be between 1620 nm and 1770 nm. Otherwise, when the rare-earth element is Tm, the first wavelength may be between 1750 nm and 2100 nm, and the second wavelength may be between 1880 nm and 2350 nm.

In the case where the multi-resonant optical fiber laser system includes the third resonator, the rare-earth element may be Yb, the first wavelength may be between 1030 nm and 1170 nm, the second wavelength may be between 1070 nm and 1250 nm, and the third wavelength may be between 1110 nm and 1340 nm. Otherwise, when the rare-earth element is either Er or Er—Yb, the first wavelength may be between 1525 nm and 1625 nm, the second wavelength may be between 1620 nm and 1770 nm, and the third wavelength may be between 1730 nm and 1950 nm. Otherwise, when the rare-earth element is Tm, the first wavelength may be between 1750 nm and 2100 nm, the second wavelength may be between 1880 nm and 2350 nm, and the third wavelength may be between 2030 nm and 2670 nm.

Table 1 shows first through third wavelengths of laser radiation, generated by a multi-resonant optical fiber laser system, with respect to rare-earth elements.

TABLE 1

| | 1^{st} Wavelength | 2^{nd} Wavelength | 3^{rd} Wavelength |
|---|---|---|---|
| Rare-Earth Element | (nm) | (nm) | (nm) |
| Yb | 1030-1170 | 1070-1250 | 1110-1340 |
| Er, Er—Yb | 1525-1625 | 1620-1770 | 1730-1950 |
| Tm | 1750-2100 | 1880-2350 | 2030-2670 |

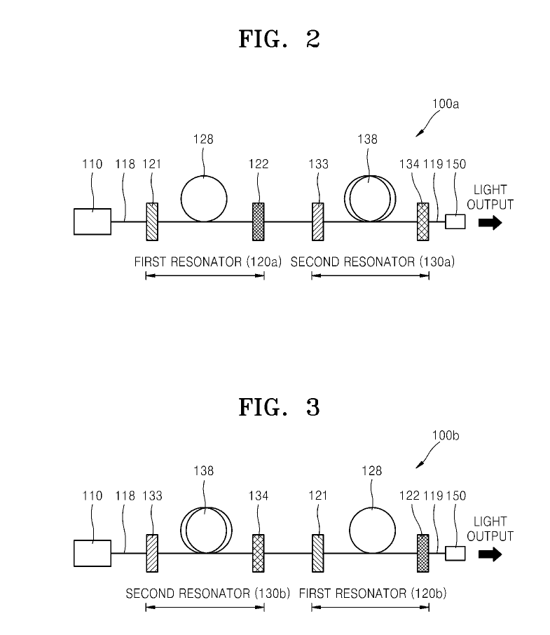

FIGS. 2 through 6 illustrates multi-resonant optical fiber laser systems 100a through 100e including first and second resonators, according to embodiments of the present invention.

Referring to FIGS. 2 through 6, the multi-resonant optical fiber laser systems 100a through 100e include pump light sources 110, first resonators 120a through 120e, second resonators 130a through 130e, and output units 150. The first resonators 120a through 120e and the second resonators 130a through 130e may include first gain medium optical fibers 128 and second gain medium optical fibers 138, respectively. Otherwise, in the case where the first resonators 120a through 120e and the second resonators 130a through 130e are overlapped, the first resonators 120a through 120e and the second resonators 130a through 130e may include both the first gain medium optical fibers 128 and the second gain medium optical fibers 138.

The first gain medium optical fiber 128 contains a rare-earth element, whereas the second gain medium optical fiber 138 contains a material inducing the Raman effect, where the material may be Ge, for example. The first and second gain medium optical fibers 128 and 138 may be connected to each other either by fusion-splicing or by using another optical fiber device. In this case, the first and second gain medium optical fibers 128 and 138 may be connected to each other such that signal distortion and splicing loss are minimized. Otherwise, the first and second gain medium optical fiber 128 and 138 can be formed by doping either the rare-earth element or the material inducing the stimulated Raman effect into a desired region of a single entity optical fiber. Generally, the first and second gain medium optical fiber 128 and 138 are surrounded by a single-cladding or double-claddings. In the case of double-cladding, pump light may be transmitted along an inner cladding of the first and second gain medium optical fiber 128 and 138.

For clarity of explanation, the first gain medium optical fiber 128 in the present invention will be assumed to be an optical fiber having a double cladding structure, whereas the second gain medium optical fiber 138 in the present invention will be assumed to be an optical fiber having a single cladding structure. However, the present invention is not limited thereto.

The pump light source 110 may be a semiconductor array diode laser for example. The pump light source 110 irradiates pump light. The wavelength of the pump light may be 980 nm or 915 nm for example.

The first resonators 120a through 120e includes the first gain medium optical fiber 128, which contains a rare-earth element, and first and second reflectors 121 and 122 arranged to face each other across the first gain medium optical fiber. Furthermore, the first resonators 120a through 120e may include the second gain medium optical fiber 138. In this case, the second gain medium optical fiber 138 does not function as a gain medium in the first resonators 120a through 120e. The first resonators 120a through 120e convert the pump light using the first gain medium optical fiber 128 and irradiates a first laser radiation having a first wavelength from the core of the first gain medium optical fiber 128. In other words, the pump light travels along an inner cladding of a first optical fiber 118 and 128 by way of total internal reflection, is absorbed through the core of the first gain medium optical fiber 128, where the core contains a rare-earth element, and acts as a pump source for the rare-earth element. Thus, laser radiation is irradiated from the core.

The second resonators 130a through 130e include the second gain medium optical fiber 138, which induces the stimulated Raman effect, and third and fourth reflectors arranged to face each other across the second gain medium optical fiber 138. Furthermore, the second resonators 130a through 130e may include the first gain medium optical fiber 128. In this case, the first gain medium optical fiber 128 does not function as a gain medium in the second resonators 130a through 130e. The second resonators 130a through 130e convert the first laser radiation using the second gain medium optical fiber 138 and irradiates a second laser radiation having a second wavelength. In other words, the first laser travels along the core of an optical fiber 138 and acts as a pump source for a material inducing the Raman effect at the core of the second gain medium optical fiber 138. As a result, the first laser radiation passes through the second resonators 130a through 130e and the second laser radiation is irradiated from the output unit 150.

Examples of the rare-earth element may include Yb, Er, Tm, or a mixture thereof, for example a mixture of Er—Yb. Furthermore, the rare-earth element may be doped into the core of the first gain medium optical fiber 128. Depending on the rare-earth materials, the range of obtained wavelengths of irradiated laser radiation varies. For example, in the case where the rare-earth element is Yb, the first wavelength of the first laser radiation is between 1030 nm and 1170 nm. Furthermore, the first laser radiation is converted to the second laser radiation due to the stimulated Raman effect of the second gain medium optical fiber 138 included in the second resonator 130a, and the second wavelength of the second laser radiation is 1070 nm and 1250 nm.

Similarly, in the case where the rare-earth element is either Er or Er—Yb, the first wavelength is between 1525 nm and 1625 nm, and the second wavelength is between 1620 nm and 1770 nm. Specifically, in the case of Er—Yb, Yb atoms are excited relatively easily by pump light. Electrons seceded from the excited Yb atoms move and excite Er atoms. As a result, the excited Er atoms irradiate laser radiation having a wavelength between 1525 nm and 1625 nm. Therefore, Yb atoms function as a sensitizer, whereas Er atoms function as an active medium actually irradiating laser radiation.

Furthermore, in the case where the rare-earth element in Tm, the first wavelength is between 1750 nm and 2100 nm, and the second wavelength is between 1880 nm and 2350 nm.

The first resonators 120a through 120e and the second resonators 130a through 130e may be either arranged apart from each other or may be overlapped. FIGS. 2 and 3 illustrate cases where the first resonators 120a through 120e and the second resonators 130a through 130e are apart from each other, whereas FIGS. 4 through 6 illustrate cases where the first resonators 120a through 120e and the second resonators 130a through 130e are overlapped. In here, ‘overlapped’ denotes that the first gain medium optical fiber 128 and the second gain medium optical fiber 138 are arranged together between the first reflector 121 and the second reflector 122 of the first resonators 120a through 120e.

The first and second reflectors 121 and 122 are arranged in a pair. Furthermore, the range of the center wavelength of the first reflector 121 and the range of the center wavelength of the second reflector 122 are configured either to be the same or at least to correspond to each other, and the ranges of center wavelengths are either the same as or correspond to the range of the first wavelength. Furthermore, the first and second reflectors 121 and 122 may each independently be an optical fiber Bragg grating (FBG), a dichroic mirror, a partial reflection mirror, an optical fiber loop mirror, or a mirror coated with a dielectric substance. Generally, the FBG, the dichroic mirror, the partial reflection mirror, the optical fiber loop mirror, and the mirror coated with a dielectric substance all reflect light having a specific wavelength or light having a wavelength which belongs to a specific range of wavelength, and light having other wavelengths passes through the same.

The third and fourth reflectors 133 and 134 are arranged in a pair. Also, the range of the center wavelength of the third reflector 133 and the range of the center wavelength of the fourth reflector 134 are configured either to be same or at least to correspond to each other, and the ranges of center wavelengths are either the same as or correspond to the range of the second wavelength. Furthermore, the third and fourth reflectors 133 and 134 may each independently be a FBG, a dichroic mirror, a partial reflection mirror, a optical fiber loop mirror, or a mirror coated with a dielectric substance. The fourth reflector 134 may have a reflectivity between 5% and 50% with respect to the second laser.

Furthermore, at least two of the first through fourth reflectors 121, 122, 133, and 134 may be multi-reflectors composed of a single body. For example, the second and fourth reflectors 122 and 134, which reflect different ranges of wavelength, may be formed by a single dichroic mirror. In this case, the dichroic mirror can cover all reflectivities of the second and fourth reflectors 122 and 134 according to each of wavelengths, and thus the number of optical devices can be reduced. The single body may be either an optical fiber loop mirror or a mirror coated with a dielectric substance.

The flow and conversion of pump light and laser within the multi-resonant optical fiber laser system 100a shown in FIG. 2 will be described hereinafter.

In the multi-resonant optical fiber laser system 100a, the first reflector 121, the first gain medium optical fiber 128, the second reflector 122, the third reflector 133, the second gain medium optical fiber 138, and the fourth reflector 134 are disposed in sequence from the pump light source 100. Pump light irradiated from the pump light source 110 passes through the first reflector 121 in the first resonator 120a and is absorbed by a rare-earth element in the core of the first gain medium optical fiber 128. At this point, the rare-earth element irradiates light with another wavelength, and the irradiated light passes through the first reflector 121 and the second reflector 122 and is irradiated as first laser radiation from the first resonator. In this case, the first reflector 121 may have a reflectivity between 90% and 100% with respect to the first laser radiation, that is, a first wavelength of the first laser radiation, whereas the second reflector 122 may have a reflectivity between 5% and 50% with respect to the first laser radiation. Therefore, the portion of the first laser radiation reflected by the second reflector 122 is reflected by the first reflector 121 toward the second reflector 122 again.

Next, the first laser passes through the third reflector 133 of the second resonator 130a, and stimulated Raman scattering occurs as the first laser passes through the second gain medium optical fiber 138. The scattered light passes through the third reflector 133 and the fourth reflector 134 and is irradiated as the second laser radiation from the second resonator 130a, and comes out of the second resonator 130a via the output unit 150. In this case, the third reflector 133 may have a reflectivity between 90% and 100% with respect to the second laser radiation, that is, a second wavelength of the second laser radiation, whereas the fourth reflector 134 may have a reflectivity between 5% and 50% with respect to the second laser radiation. Therefore, the portion of the second laser reflected by the fourth reflector 134 is reflected by the third reflector 133 toward the fourth reflector 134 again. The repeated reflections boost the stimulated Raman effect of the second laser. Furthermore, the second reflector 122 and the third reflector 133 may be multi-reflectors composed of a single body. The multi-reflectors may have reflectivities between 5% and 50% with respect to the first laser radiation and reflectivities between 90% and 100% with respect to the second laser radiation.

The multi-resonant optical fiber laser system 100b through 100e shown in FIGS. 3 through 6 includes configurations same as the configuration of the multi-resonant optical fiber laser system 100a shown in FIG. 2. However, in FIGS. 3 through 6, arrangements of the first through fourth reflectors 121, 122, 133, and 134 from the pump light source 110 are different from that of the first through fourth reflectors 121, 122, 133, and 134 shown in FIG. 2. The function of the first through fourth reflectors 121, 122, 133, and 134 is the same as that of the first through fourth reflectors 121, 122, 133, and 134 shown in FIG. 2, but differences of reflectivity of each may vary according to the arrangements. Therefore, for clarity of explanation, descriptions on components duplicate with those shown in FIG. 2 will be omitted.

In the multi-resonant optical fiber laser system shown in FIG. 3, arrangement of the first resonator 120b and the second resonator 130b are switched when compared to the multi-resonant optical fiber laser system shown in FIG. 2. In other words, in the first resonator 120b and the second resonator 130b, the third reflector 133, the second gain medium optical fiber 138, the fourth reflector 134, the first reflector 121, the first gain medium optical fiber 128, and the second reflector 122 are disposed in sequence from the pump light source 110. Pump light irradiated from the pump light source 110 passes through the third reflector 133 and the fourth reflector 134 of the second resonator 130b and is converted to first laser radiation by the first reflector 121, the first gain medium optical fiber 128, and the second reflector 122. The first laser radiation passes through the first gain medium optical fiber 128 and is irradiated to the first reflector 121. The first laser radiation passes through the fourth reflector 134, undergoes stimulated Raman scattering in the second gain medium optical fiber 138, and is converted to second laser radiation by the third reflector 133 and the fourth reflector 134, where the second gain medium optical fiber 138, the third reflector 133, and the fourth reflector 134 are components of the second resonator 130b. The second laser radiation is irradiated to the fourth reflector 134, passes through the first reflector 121 and the second reflector 122, and outputs energy to the output unit 150. In the configuration, the first reflector 121 may have a reflectivity between 5% and 50% with respect to the first laser radiation, and the fourth reflector 134 may have a reflectivity between 5% and 50% with respect to the second laser radiation. The second reflector 122 may have a reflectivity between 90% and 100% with respect to the first laser radiation. Furthermore, the third reflector 133 may have a reflectivity between 90% and 100% with respect to the second laser radiation, and the first and second reflectors 121 and 122 may have little reflectivity with respect to the second laser radiation. The third and fourth reflectors 133 and 134 may have little reflectivity with respect to the first laser radiation. Furthermore, the first reflector 121 and the fourth reflector 134 may be multi-reflectors composed of a single body. The multi-reflectors may have reflectivities between 5% between 50% with respect to the first and second laser radiations.

FIGS. 4 through 6 illustrate cases in which the first resonators 120c through 120e and the second resonators 130c through 130e are overlapped. In other words, the first gain medium optical fiber 128 and the second gain medium optical fiber 138 are disposed together between the first resonators 120c through 120e and the second resonators 130c through 130e.

Referring to FIG. 4, in the first resonator 120c and the second resonator 130c of the multi-resonant optical fiber laser system 100c, the first reflector 121, the first gain medium optical fiber 128, the third reflector 133, the second gain medium optical fiber 138, the second reflector 122, and the fourth reflector 134 are disposed in sequence from the pump light source 110. Pump light irradiated from the pump light source 110 passes through the first reflector 121 of the first resonator 120c and excites rare-earth ions in the first gain medium optical fiber 128. The excited rare-earth material irradiates light. The light is reflected through the first reflector 121 and the second reflector 122 and is converted to first laser radiation. The first laser radiation is converted to second laser radiation by the second gain medium optical fiber 138, the third reflector 133, and the fourth reflector 134, and the second laser passes through the second reflector 122 and the fourth reflector 134 and is output from the output unit 150. In here, part of the first laser radiation not converted in the second gain medium optical fiber 138 is reflected by the second reflector 122 and passes through the second gain medium optical fiber 138 again. Thus, an efficiency of converting the first laser radiation to the second laser radiation can be improved. The converted second laser radiation is reflected by the third reflector 133, and passes through the fourth reflector 134, and is output from the output unit 150. In the configuration, the first and second reflectors 121 and 122 may have reflectivities between 90% and 100% with respect to the first laser radiation. Furthermore, the third reflector 133 may have a reflectivity between 90% and 100% with respect to the second laser radiation, and the fourth reflector 134 may have a reflectivity between 5% and 50% with respect to the second laser radiation. Location of the second reflector 122 and location of the fourth reflector 134 may be switched to each other. Furthermore, the second reflector 122 and the fourth reflector 134 may be multi-reflectors composed of a single body. The multi-reflectors may have reflectivities between 90% and 100% with respect to the first laser radiation and reflectivities between 5% and 50% with respect to the second laser radiation. Generally, in an optical fiber laser, the length of an optical fiber which can be employed depends on the energy of pump light, a material inducing the Raman effect in a gain medium, concentration of a rare-earth element, resonator loss, and/or a reflectivity of a reflector. The multi-resonant optical fiber laser system 100c shown in FIG. 4 can obtain laser with higher output power as compared to the multi-resonant optical fiber laser systems shown in FIGS. 2 and 3. In the structures shown in FIG. 2 or FIG. 3, part of energy of the first laser is continuously trapped in the first resonators 120a or 120b, whereas the other energy extracted from the first resonators 120a or 120b is just converted to the second laser in the second resonators 130a or 130b. However, as in the case of FIG. 4, since the first resonator 120c and the second resonator 130c are overlapped and the first laser is almost completely trapped in the first resonator 120c due to the first reflector 121 and the second reflector 122 with a high reflection, the first laser cannot leak outside without external perturbations. The only way to extract the first resonators 120a or 120b is a wavelength conversion by stimulated Raman scattering in an optical fiber 138. The first laser with high power is easily converted to stoke wavelengths in a optical fiber 138 by successive stimulated Raman scatterings and the scattered or converted lights escape the first resonator 120c as light having a new wavelength. The escaped energy is transformed to the second laser radiation by the second resonator 130c, that is, the third reflector 133, the second gain medium optical fiber 138, and the fourth reflector 134. As a result, most of the energy of the first laser trapped in the first resonator 120c is converted to the second laser radiation, and thus the multi-resonant optical fiber laser system shown in FIG. 4 is more efficient than those shown in FIGS. 2 and 3.

In the multi-resonant optical fiber laser system shown in FIG. 5, arrangement of the first resonator 120d and the second resonator 130d are switched as compared to the multi-resonant optical fiber laser system shown in FIG. 4. In other words, in the first resonator 120d and the second resonator 130d, the third reflector 133, the first reflector 121, the second gain medium optical fiber 138, the fourth reflector 134, the first gain medium optical fiber 128, and the second reflector 122 are disposed in sequence from the pump light source 110. Pump light irradiated from the pump light source 110 passes through the third reflector 133, the first reflector 121, the second gain medium optical fiber 138, and the fourth reflector 134. Next, the pump light is converted to first laser radiation by the first reflector 121 and the second reflector 122 as the pump light travels through the first gain medium optical fiber 128. The first laser radiation undergoes Raman scattering by the second gain medium optical fiber 138, undergoes stimulated Raman scattering by the third reflector 133 and the fourth reflector 134, and is converted to second laser radiation. The second laser radiation is output from the fourth reflector 134, travels through the first gain medium optical fiber 128 and the second reflector 122, and is output from the output unit 150. In the configuration, the first reflector 121 and the second reflector 122 may have reflectivities between 90% and 100% with respect to the first laser radiation. The third reflector may have a reflectivity between 90% and 100% with respect to the second laser radiation. The fourth reflector may have a reflectivity between 5% and 50% with respect to the second laser radiation. Furthermore, the first and second reflectors 121 and 122 may have little reflectivity with respect to the second laser radiation, and the third and fourth reflectors 133 and 134 may have little reflectivity with respect to the first laser radiation. Furthermore, the first reflector 121 and the third reflector 133 may be multi-reflectors composed of a single body. The multi-reflectors may have reflectivities between 90% between 100% with respect to the first and second laser radiations.

In the first resonator 120e and the second resonator 130e of the multi-resonant optical fiber laser system 100e shown in FIG. 6, the first reflector 121, the third reflector 133, the first gain medium optical fiber 128, the second gain medium optical fiber 138, the fourth reflector 134, and the second reflector 122 are disposed in sequence from the pump light source 110. Pump light irradiated from the pump light source 110 travels through the first reflector 121 and the third reflector 133, and is converted to first laser radiation by the first and second reflectors 121 and 122 as the pump light travels through the first gain medium optical fiber 128. The first laser radiation is converted to second laser radiation by the third and fourth reflectors 133 and 134 as the first laser radiation travels through the second gain medium optical fiber 138. Next, the second laser radiation travels through the fourth reflector 134 and the second reflector 122, and is output from the output unit 150. In the configuration, the first reflectors 121 and the second reflectors 122 may have reflectivities between 90% and 100% with respect to the first laser radiation. The third reflector 133 may have a reflectivity between 90% and 100% with respect to the second laser radiation. The fourth reflector 134 may have a reflectivity between 5% and 50% with respect to the second laser radiation. Furthermore, the first reflector 121 and the third reflector 133 may be multi-reflectors composed of a single body. The multi-reflectors may have reflectivities between 90% between 100% with respect to the first and second laser radiations. Furthermore, the second reflector 122 and the fourth reflector 134 may be multi-reflectors each of which is composed of a single body. The multi-reflectors may have reflectivities between 90% between 100% with respect to the first laser radiation and reflectivities between 5% and 50% with respect to the second laser radiation. Furthermore, location of the first reflector 121 and location of the third reflector 133 may be switched with each other, and location of the second reflector 122 and location of the fourth reflector 134 may be switched with each other. Furthermore, location of the first gain medium optical fiber 128 and location of the second gain medium optical fiber 138 may be switched with each other.

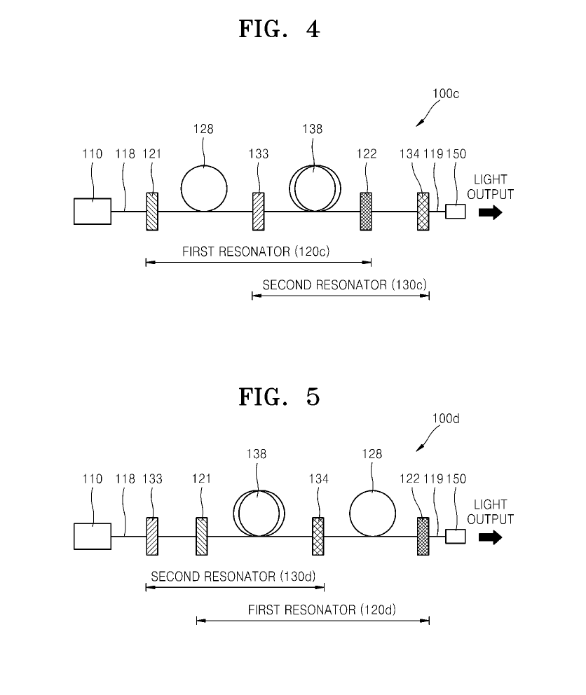

FIGS. 7 through 9 illustrate multi-resonant optical fiber laser systems 200a through 200c according to other embodiments of the present invention.

Referring to FIGS. 7 through 9, the multi-resonant optical fiber laser systems 200a through 200c include first resonators 220a through 220c and second resonators 230a through 230c, where the first resonators 220a through 220c and the second resonators 230a through 230c are similar to those described in reference with FIGS. 2 through 6. Furthermore, the multi-resonant optical fiber laser systems 200a through 200c include third resonators 240a through 240c. The third resonators 240a through 240c include the second gain medium optical fibers 238 and fifth and sixth reflectors 245 and 246 arranged to face each other across the second gain medium optical fiber 238. The third resonators 240a through 240c convert the second laser radiation by using the second gain medium optical fiber 238 and irradiate third laser radiation having a third wavelength. The principle of irradiating the third laser radiation uses the stimulated Raman effect as described for the second laser radiation.

Furthermore, the third wavelength of the third laser radiation is between 1110 nm and 1340 nm in the case where the rare-earth element is Yb, is between 1730 nm and 1950 nm in the case where the rare-earth element is either Er or Er—Yb, and is between 2030 nm and 2670 nm in the case where the rare-earth element is Tm.

The fifth and sixth reflectors 245 and 246 are arranged in pairs. Furthermore, the range of the center wavelength of the fifth reflector 245 and the range of the center wavelength of the sixth reflector 246 are configured either to be same or at least to correspond to each other, and the ranges of center wavelengths are either the same as each other or correspond to range of the third wavelength. Furthermore, the fifth and sixth reflectors 245 and 246 may each independently be a optical fiber Bragg grating (FBG), a dichroic mirror, a partial reflection mirror, a optical fiber loop mirror, or a mirror coated with a dielectric substance. The sixth reflector 246 may have a reflectivity between 5% and 50% with respect to the third laser.

Furthermore, the first through third resonators 220a through 220c, 230a through 230c, and 240a through 240c may be either arranged apart from each other or may be overlapped. Since the second resonators 230a through 230c and the third resonators 240a through 240c share the second gain medium optical fiber 238, they are overlapped.

FIG. 7 illustrates a case where the first resonator 220a is arranged apart from the second and third resonators 230a and 240a, whereas FIGS. 8 and 9 illustrate cases where the first resonators 220b and 220c are overlapped with the second and third resonators 230b, 230c, 240b, and 240c. In other words, in the first through third resonators 220a, 230a, and 240a of FIG. 7, a first reflector 221, a first gain medium optical fiber 228, a second reflector 222, a third reflector 233, the fifth reflector 245, the second gain medium optical fiber 238, a fourth reflector 234, and the sixth reflector 246 are disposed in sequence from a pump light source 210. In the first through third resonators 220b, 230b, and 240b of FIG. 8, the first reflector 221, the first gain medium optical fiber 228, the third reflector 233, the fifth reflector 245, the second gain medium optical fiber 238, the second reflector 222, the fourth reflector 234, and the sixth reflector 246 are disposed in sequence from the pump light source 210. In the first through third resonators 220c, 230c, and 240c of FIG. 9, the fifth reflector 245, the third reflector 233, the first reflector 221, the first gain medium optical fiber 228, the second gain medium optical fiber 238, the second reflector 222, the fourth reflector 234, and the sixth reflector 246 are disposed in sequence from the pump light source 210. However, the present invention is not limited thereto, and the components may be arranged in various combinations.

In other words, in the multi-resonant optical fiber laser system shown in FIG. 7, the locations of the second reflector 222, the third reflector 233, and the fifth reflector 245 can be switched with each other, and the locations of the fourth reflector 234 and the sixth reflector 246 can be switched with each other. In the multi-resonant optical fiber laser system shown in FIG. 8, the locations of the third reflector 233 and the fifth reflector 245 can be switched with each other, and the locations of the second reflector 222, the fourth reflector 234, and the sixth reflector 246 can be switched with each other. In the multi-resonant optical fiber laser system shown in FIG. 9, the locations of the first reflector 221, the third reflector 233, and the fifth reflector 245 can be switched with each other, and the locations of the second reflector 222, the fourth reflector 234, and the sixth reflector 246 can be switched with each other. The first through fifth reflectors 221, 222, 233, 234, and 245 may have different reflectivities with respect to the first through third lasers according to the arrangement.

Furthermore, two or more of the first through sixth reflectors 221, 222, 233, 234, 245, and 246 may be multi-reflectors composed of a single body. In the multi-resonant optical fiber laser system shown in FIG. 7, two or all of the second reflector 222, the third reflector 233, and the fifth reflector 245 may be multi-reflectors composed of a single body, and the fourth reflector 234 and the sixth reflector 246 may be multi-reflectors composed of a single body. In the multi-resonant optical fiber laser system shown in FIG. 8, the third reflector 233 and the fifth reflector 245 may be multi-reflectors composed of a single body, and two or all of the second reflector 222, the fourth reflector 234, and the sixth reflector 246 may be multi-reflectors composed of a single body. In the multi-resonant optical fiber laser system shown in FIG. 9, two or all of the first reflector 221, the third reflector 233, and the fifth reflector 245 may be multi-reflectors composed of a single body, and two or all of the second reflector 222, the fourth reflector 234, and the sixth reflector 246 may be multi-reflectors composed of a single body. However, the present invention is not limited thereto. According to the principle described above, the multi-reflectors may have reflectivities with respect to the first through third laser, the reflectivities being appropriate according to the locations of the multi-reflectors.

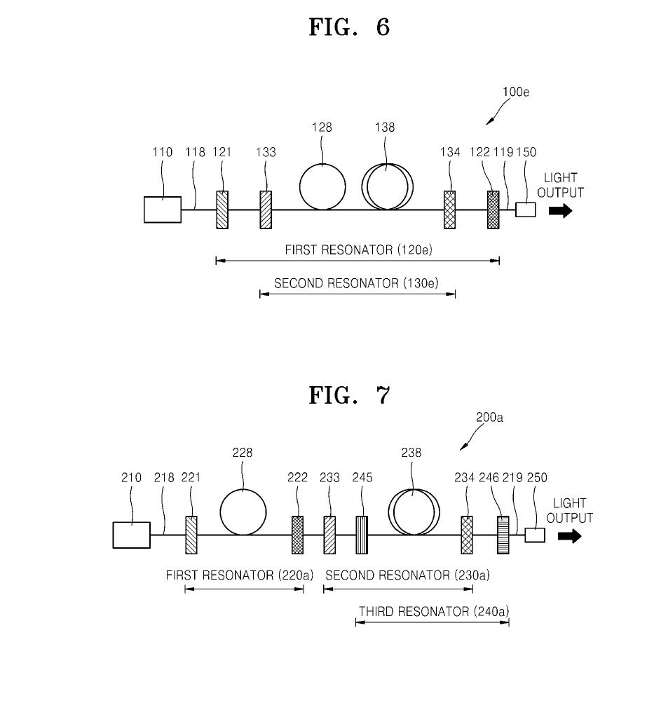

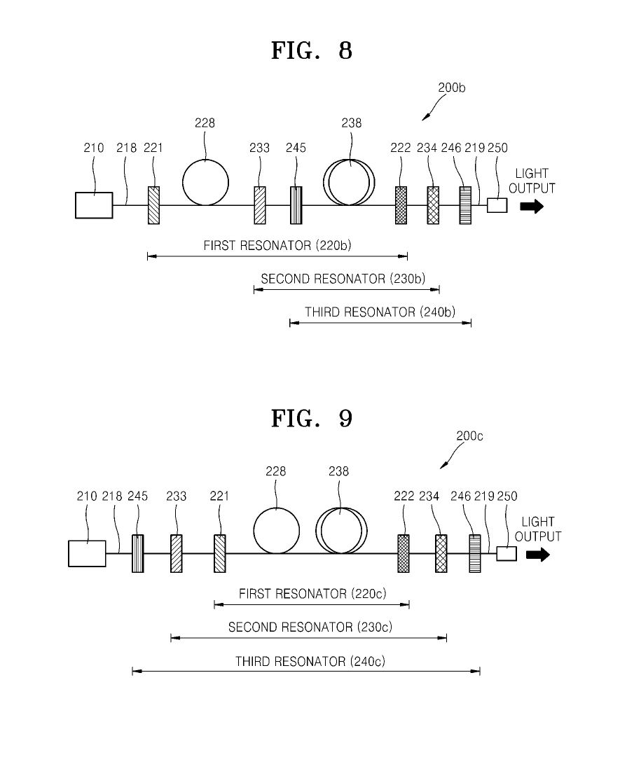

FIG. 10A illustrates a dichroic mirror 152, which is a reflector included in the multi-resonant optical fiber laser systems shown in FIGS. 2 through 9, and an output unit 150 according to an embodiment of the present invention. FIG. 10B is a graph illustrating reflectivity characteristics of the dichroic mirror 152 of FIG. 10A with respect to wavelength.

Referring to FIG. 10A, a reflector located close to the output unit 150 is the dichroic mirror 152. The dichroic mirror 152 may be the multi-reflector. Referring to FIG. 10B, the dichroic mirror 152 has dichroic reflectivities over a relatively large area. The dichroic mirror 152 has a high reflectivity at short wavelengths, and has low reflectivity at long wavelengths. The reflective characteristics of the dichroic mirror may vary according to configuration. For example, the dichroic mirror may have low reflectivity at short wavelengths and high reflectivity at long wavelengths. Furthermore, the dichroic mirror may also have either high or low reflectivity in a specific band of wavelengths. In the case of a FBG, the width of a band is generally as small as 2 nm. Therefore, when a resonator is formed with a pair of FBGs, ranges of center wavelengths of the FBGs may not match with each other correctly. The incorrect matching may either be induced during manufacture or be caused by internal heat due to either outer temperature or optical fiber laser. However, since the dichroic mirror 152 has a relatively wider band as compared to the FBG, ranges of center wavelengths can be matched with each other easier as compared to the FBG. The range of median reflectivities of the dichroic mirror 152 between high reflectivities and low reflectivities depends on methods of configuring laser. Furthermore, the output unit 150 may further include a separate dichroic mirror 152. In FIG. 10A, an angled cleaving 154 and an anti-reflection coating 156 are further included on an end of the dichroic mirror 152 to improve light propagation and to reduce reflection from ends of the optical fiber.

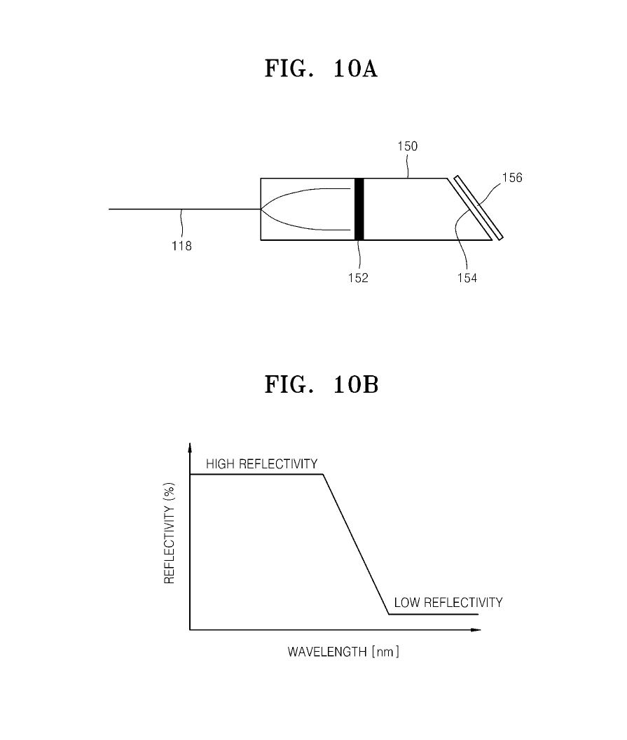

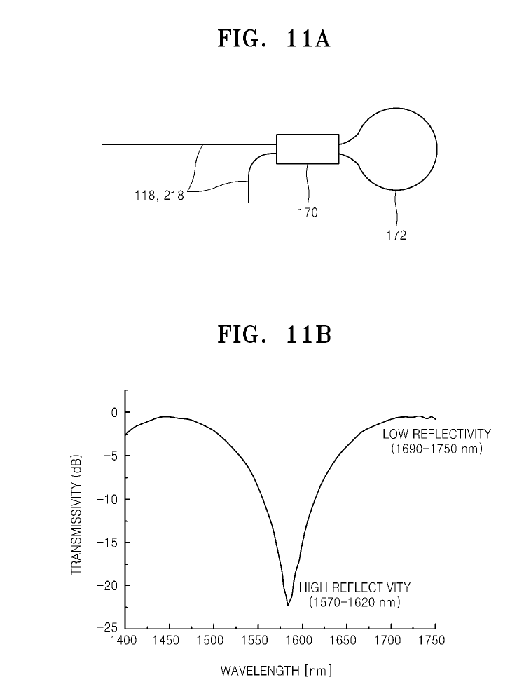

FIG. 11A illustrates a optical fiber loop mirror 170, employed as a reflector in the multi-resonant optical fiber laser systems shown in FIGS. 2 through 9, according to an embodiment of the present invention. FIG. 11B is a graph illustrating reflectivity characteristics of the optical fiber loop mirror 170 of FIG. 11A with respect to wavelengths.

Referring to FIG. 11A, the optical fiber loop mirror 170 includes an optical fiber loop 172, may replace the reflector (i.e. a FBG), and may be used as the multi-reflector. Furthermore, since the optical fiber loop mirror 170 is an optical fiber, the optical fiber loop mirror 170 can be connected to the first and second optical fibers 119 and 219 by fusion splicing. The optical fiber loop mirror 170 can be used as a reflector located close to the output unit 150. Referring to FIG. 11B, the optical fiber loop mirror 170 has high reflectivity (that is, low transmissivity) with respect to light with wavelengths between 1570 nm and 1620 nm, and has low reflectivity (that is, high transmissivity) with respect to light with wavelengths between 1690 nm and 1750 nm. Therefore, as described in reference with FIG. 10B, the optical fiber loop mirror 170 has the advantage of having a wide band of reflectivities. However, the range of wavelengths, the reflectivities, the shape, and the components of the optical fiber loop mirror 170 are merely examples, and the present invention is not limited thereto.

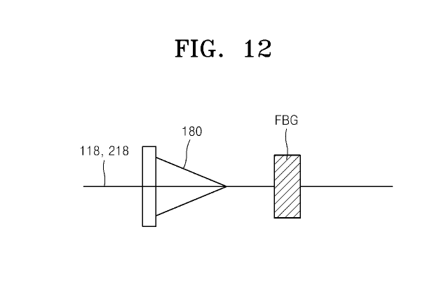

FIG. 12 illustrates an acousto-optic modulator 180, which is for a Q-switching laser and is connected to a reflector included in the multi-resonant optical fiber laser systems shown in FIGS. 2 through 9.

Referring to FIG. 12, the reflector may be a FBG, and the acousto-optic modulator 180 may be installed to an end of an FBG attached to the optical fibers 118 and 218. The acousto-optic modulator 180 applies shear stress to the FBG according to a radio frequency (RF) signal, for example. Thus, the location of a center wavelength of the FBG can be changed due to the frequency of the acousto-optic modulator 180. In other words, first order peaks of reflectivity are formed at wavelengths above and below the center wavelength of the FBG. A wavelength at the first order peaks of reflectivity varies according to the RF signal applied to the acousto-optic modulator 180, and disappears if no RF signal is applied. The multi-resonant optical fiber laser system can embody a continuous wave (CW) laser. Furthermore, the multi-resonant optical fiber laser system can also embody a Q-switched pulsed wave laser by using the acousto-optic modulator 180. The acousto-optic modulator 180 can be attached to at least one or more of the first through sixth reflectors. However, minimization of Fresnel reflection from the output unit 150 may be required, and either angled cleaving or anti-reflection coating may be required on ends of the optical fibers 119 and 219. Furthermore, a general collimator can be further attached to the output unit 150 such that irradiated laser does not diverge.

Furthermore, a pulsed laser can be embodied by attaching a bulk acousto-optic modulating device outside the multi-resonant optical fiber laser system according to the present invention. Furthermore, a pulsed laser can be embodied by modulating a CW laser obtained from the multi-resonant optical fiber laser system according to the present invention. The modulation can be performed by mechanical chopping, acousto-optic modulation, or electro-optic modulation. Examples of devices for the modulation include a light intensity modulator, a light phase modulator, a light saturation absorber, or an acousto-optic modulator. Those modulators can be attached inside or outside the multi-resonant optical fiber laser system according to the present invention.

The present invention provides a multi-resonant optical fiber laser system including a first resonator formed of a gain medium containing a rare-earth element and a second and third resonator formed of a gain medium inducing the stimulated Raman effect. The multi-resonant optical fiber laser system can embody a laser with wavelengths in ranges which cannot be embodied by using only a rare-earth element optical fiber-laser.

The multi-resonant optical fiber laser system according to the present invention can irradiate laser radiation with wavelengths highly absorbable to fats in the human body while not being highly absorbable by water and other cells of the human body, and thus can be effectively used in lipectomy.

Furthermore, the multi-resonant optical fiber laser system according to the present invention can irradiate high power, single mode, and high quality light (that is, excellent Gaussian beam) by using pump light irradiated from a semiconductor laser irradiating low quality light, and thus can be applied to medical or industrial laser requiring precision.

The foregoing is illustrative of example embodiments and is not to be construed as limiting thereof. Although example embodiments have been described, those skilled in the art will readily appreciate that many modifications are possible in example embodiments without materially departing from the novel teachings and advantages of example embodiments. Accordingly, all such modifications are intended to be included within the scope of the claims. Therefore, it is to be understood that the foregoing is illustrative of example embodiments and is not to be construed as limited to the specific embodiments disclosed, and that modifications to the disclosed embodiments, as well as other embodiments, are intended to be included within the scope of the appended claims. Example embodiments are defined by the following claims, with equivalents of the claims to be included therein.

What is claimed is:

1. A multi-resonant optical fiber laser system comprising:
a pump light source irradiating pump light;
a first resonator comprising:
a first gain medium optical fiber containing at least one rare-earth element; and
first and second reflectors disposed to face each other across the first gain medium optical fiber,
and irradiating first laser radiation having a first wavelength by converting the pump light using the first gain medium optical fiber; and
a second resonator comprising:
a second gain medium optical fiber inducing a stimulated Raman effect; and
third and fourth reflectors disposed to face each other across the second gain medium optical fiber,
and irradiating second laser radiation having a second wavelength by converting the first laser radiation using the second gain medium optical fiber.

2. The multi-resonant optical fiber laser system of claim 1, wherein the rare-earth element is Yb (ytterbium), Er (erbium), Tm (Thulium), or a mixture thereof.

3. The multi-resonant optical fiber laser system of claim 1, wherein the first wavelength is between 1030 nm and 1170 nm, between 1525 nm and 1625 nm, or between 1750 nm and 2100 nm.

4. The multi-resonant optical fiber laser system of claim 1, wherein the second wavelength is between 1070 nm and 1250 nm, between 1620 nm and 1770 nm, or between 1180 nm and 2350 nm.

5. The multi-resonant optical fiber laser system of claim 1, wherein the rare-earth element is Yb, the first wavelength is between 1030 nm and 1170 nm, and the second wavelength is between 1070 nm and 1250 nm.

6. The multi-resonant optical fiber laser system of claim 1, wherein the rare-earth element is either Er or a mixture of Er and Yb, the first wavelength is between 1525 nm and 1625 nm, and the second wavelength is between 1620 nm and 1770 nm.

7. The multi-resonant optical fiber laser system of claim 1, wherein the rare-earth element is Tm, the first wavelength is between 1750 and 2100 nm, and the second wavelength is between 1880 nm and 2350 nm.

8. The multi-resonant optical fiber laser system of claim 1, wherein the first resonator and the second resonator are either disposed apart from each other or are overlapped.

9. The multi-resonant optical fiber laser system of claim 1, wherein the second gain medium optical fiber of the second resonator is disposed between the first and second reflectors.

10. The multi-resonant optical fiber laser system of claim 1, wherein possible sequences in which the first through fourth reflectors are disposed in a direction away from the pump light source are:
the first reflector, the second reflector, the third reflector, and the fourth reflector;
the first reflector, the third reflector, the second reflector, and the fourth reflector;
the first reflector, the third reflector, the fourth reflector, and the second reflector;
the third reflector, the first reflector, the second reflector, and the fourth reflector;
the third reflector, the first reflector, the fourth reflector, and the second reflector; and
the third reflector, the fourth reflector, the first reflector, and the second reflector.

11. The multi-resonant optical fiber laser system of claim 1, wherein the first through fourth reflectors are each independently a FBG (optical fiber Bragg grating), a dichroic mirror, a partial reflection mirror, a optical fiber loop mirror, or a mirror coated with dielectric substance.

12. The multi-resonant optical fiber laser system of claim 1, wherein the range of the center wavelength of the first reflector and the range of the center wavelength of the second reflector correspond to each other, and the range of the center wavelength of the third reflector and the range of the center wavelength of the fourth reflector correspond to each other.

13. The multi-resonant optical fiber laser system of claim 1, wherein the first reflector has a reflectivity between 5% and 50% or a reflectivity between 90% and 100% with respect to the first laser radiation.

14. The multi-resonant optical fiber laser system of claim 1, wherein the second reflector has a reflectivity between 5% and 50% or a reflectivity between 90% and 100% with respect to the first laser radiation.

15. The multi-resonant optical fiber laser system of claim 1, wherein the third reflector has a reflectivity between 90% and 100% with respect to the second laser radiation.

16. The multi-resonant optical fiber laser system of claim 1, wherein the fourth reflector has a reflectivity between 5% and 50% with respect to the second laser radiation.

17. The multi-resonant optical fiber laser system of claim 1, wherein two of the first through fourth reflectors are multi-reflectors composed of a single body.

18. The multi-resonant optical fiber laser system of claim 1, wherein the first gain medium optical fiber, the second gain medium optical fiber, or both comprise silica as host glass.

19. The multi-resonant optical fiber laser system of claim 18, wherein the first gain medium optical fiber, the second gain medium optical fiber, or both further comprise Al₂O₃ and GeO₂, respectively or both.

20. The multi-resonant optical fiber laser system of claim 1, wherein the second gain medium optical fiber comprises Ge (germanium).

21. The multi-resonant optical fiber laser system of claim 1, wherein the first gain medium optical fiber, the second gain medium optical fiber, or both are optical fibers have either a single cladding structure or a double cladding structure.

22. The multi-resonant optical fiber laser system of claim 1, further comprising a light intensity modulator, a light phase modulator, light saturation absorber, or an acousto-optic modulator.

23. A multi-resonant optical fiber laser system comprising:
a pump light source irradiating pump light;
a first resonator comprising:
a first gain medium optical fiber containing at least one rare-earth element;
first and second reflectors disposed to face each other across the first gain medium optical fiber,
and irradiating first laser radiation having a first wavelength by converting the pump light using the first gain medium optical fiber;
a second resonator comprising:
a second gain medium optical fiber inducing a stimulated Raman effect;
third and fourth reflectors disposed to face each other across the second gain medium optical fiber,
and irradiating second laser radiation having a second wavelength by converting the first laser radiation using the second gain medium optical fiber; and
a third resonator comprising:
fifth and sixth reflectors disposed to face each other across the second gain medium optical fiber,
and irradiating third laser radiation having a third wavelength by converting the second laser radiation using the second gain medium optical fiber.

24. The multi-resonant optical fiber laser system of claim 23, wherein the first wavelength is between 1030 nm and 1170 nm, between 1525 nm and 1625 nm, or between 1750 nm and 2100 nm,
the second wavelength is between 1070 nm and 1250 nm, between 1620 nm and 1770 nm, or between 1880 nm and 2350 nm, and
the third wavelength is between 1110 nm and 1340 nm, between 1730 nm and 1950 nm, or between 2030 nm and 2670 nm.

25. The multi-resonant optical fiber laser system of claim 23, wherein the rare-earth element is Yb, the first wavelength is between 1030 nm and 1170 nm, the second wavelength is between 1070 nm and 1250 nm, and the third wavelength is between 1110 nm and 1340 nm.

26. The multi-resonant optical fiber laser system of claim 23, wherein the rare-earth element is either Er or Er—Yb, the first wavelength is between 1525 nm and 1625 nm, the second wavelength is between 1620 nm and 1770 nm, and the third wavelength is between 1730 nm and 1950 nm.

27. The multi-resonant optical fiber laser system of claim 23, wherein the rare-earth element is Tm, the first wavelength is between 1750 nm and 2100 nm, the second wavelength is between 1880 nm and 2350 nm, and the third wavelength is between 2030 nm and 2670 nm.

28. The multi-resonant optical fiber laser system of claim 23, wherein positions of the first through third resonators are either disposed apart from each other or are overlapped.

29. The multi-resonant optical fiber laser system of claim 23, wherein possible sequences in which the first through sixth reflectors are disposed in a direction away from the pump light source are:
first reflector, second reflector, third reflector, fifth reflector, fourth reflector, sixth reflector;
first reflector, third reflector, fifth reflector, second reflector, fourth reflector, sixth reflector; and
fifth reflector, third reflector, first reflector, second reflector, fourth reflector, sixth reflector.

30. The multi-resonant optical fiber laser system of claim 23, wherein the first through sixth reflectors are each independently a FBG (optical fiber Bragg grating), a dichroic mirror, a partial reflection mirror, a optical fiber loop mirror, or a mirror coated with dielectric substance.

31. The multi-resonant optical fiber laser system of claim 23, wherein the range of the center wavelength of the first reflector and the range of the center wavelength of the second reflector correspond to each other, the range of the center wavelength of the third reflector and the range of the center wavelength of the fourth reflector correspond to each other, and the range of the center wavelength of the fifth reflector and the range of the center wavelength of the sixth reflector correspond to each other.

32. The multi-resonant optical fiber laser system of claim 23, wherein the fifth reflector has a reflectivity between 90% and 100% with respect to the third laser radiation.

33. The multi-resonant optical fiber laser system of claim 23, wherein the sixth reflector has a reflectivity between 5% and 50% with respect to the third laser radiation.

34. The multi-resonant optical fiber laser system of claim 23, wherein two or three of the first through sixth reflectors are multi-reflectors composed of a single body.

35. The multi-resonant optical fiber laser system of claim 23, wherein the second gain medium optical fiber comprises Ge.

36. The multi-resonant optical fiber laser system of claim 23, wherein the first gain medium optical fiber, the second gain medium optical fiber, or both are optical fibers having either a single cladding structure or a double cladding structure.

37. A multi-resonant optical fiber laser system comprising:
a first resonator including a first gain medium containing at least one rare-earth element; and
a second resonator including a second gain medium inducing a stimulated Raman effect,
wherein the multi-resonant optical fiber laser system irradiates laser radiation by using the first gain medium and the second gain medium in sequence.

38. The multi-resonant optical fiber laser system of claim 37, wherein the first resonator and the second resonator are either disposed apart from each other or are overlapped.

39. The multi-resonant optical fiber laser system of claim 37, further comprising a third resonator including the second gain medium optical fiber, wherein the multi-resonant optical fiber laser system irradiates laser radiation by using the first gain medium optical fiber and repeatedly using the second gain medium optical fiber.

40. The multi-resonant optical fiber laser system of claim 37, wherein positions of the first through third resonators are either disposed apart from each other or are overlapped.
